(19) United States
(12) Patent Application Publication
(10) Pub. No.: US 2008/0157607 A1
(43) Pub. Date: Jul. 3, 2008

(54) Linear unit

(76) Inventors: Hubert Scheich, Eiterfeld (DE); Hugo Isert, Dermbach (DE)

Correspondence Address: CLARK & BRODY, 1090 VERMONT AVENUE, NW, SUITE 250, WASHINGTON, DC, 20005, US

(21) Appl. No.: 11/987,122

(22) Filed: Nov. 27, 2007

(30) Foreign Application Priority Data
Nov. 29, 2006 (DE) 10 2006 056 516.9

(51) Int. Cl. F16C 29/06; H02K 41/02

(52) U.S. Cl. 310/12; 384/15

(57) ABSTRACT

The present invention relates to a linear unit comprising at least one guide rail 12, at least one substantially U shaped carriage 40 displaceable on the guide rail 12, and a transverse support segment 42 and two lateral leg segments 44, where the segments 42, 44 partly enclose the guide rail 12, further a playfree bearing configured between the guide rail 12 and the carriage 40 and at least two bearing elements and at least two bearing surfaces 14 constituted at the guide rail 12 to brace and guide the bearing elements, and means to adjust the bearing in playfree manner.

In the invention, the bearing elements are designed in a manner that they are rotatable relative to the guide rail 12 and the carriage 40 to adjust the bearing in playfree manner.

The rotatable design of the bearing elements of the invention assures that they automatically align themselves with respect to the corresponding bearing surfaces when the bearing is being adjusted.

### LIST OF REFERENCES

X-X longitudinal axis
Y-Y Transverse axis
Z-Z vertical axis
2 cover plate
4 cover plate
5 screw
6 electric connectors
8 screw
10 linear unit
12 guide rail
14 bearing surface
15 groove
16 receiving cavity
18 recess
20 groove
22 free space
24 recess
26 recess
28 groove
30 base
32 groove
34 aperture
36 cover tape
38 screw
39 protrusion
40 carriage
41 offsets
42 transverse support segment
44 leg segment
46 seat
48 bearing surface
50 gap
52 recess
54 groove
56 chamber
58 chamber
60 groove
62 borehole
64 borehole
70 retention element
72 roller chain
74 roller
80 coil
82 permanent magnet
84 spacer
86 flange
88 threaded bar
90 magnetic strip
92 seal
100 steel sheet
101 steel sheet
102 dovetail portion of a groove
104 flange
106 hexagon
108 Allen screw/hexagonal head screw
110 groove

### Linear Unit

The present invention relates to a linear unit comprising a guide rail respectively a support bar or the like, a carriage displaceable on the guide rail respectively the support bar, a play-free bearing configured between the guide rail respectively the support bar, said bearing being fitted with bearing and support surfaces at the guide rail respectively the support bar to brace and guide the bearing elements, and means to adjust the bearing in play-free manner.

Linear units of the above kind are used in numerous industrial fields of application, in particular because they allow accurate, translational displacements. The design of known linear units usually is fairly complex and based on many components. Accordingly the manufacture and assembly of such linear units are very time-consuming and expensive. Maintenance work such as exchanging worn bearing components in general are very time consuming and hence cost intensive.

Accordingly it is the objective of the present invention to solve these and further drawbacks of the state of the art and to create a linear unit of the above cited kind which is built economically using simple components and assures accurate as well as constantly reliable guidance. This unit shall be manufactured and assembled rapidly and rationally. Moreover it allows quick and simple exchange of parts.

This problem is solved by the features of claim 1. Preferred embodiment modes are the objects of the dependent claims.

The linear unit of the present invention comprises at least one guide rail, at least one substantially U-shaped carriage displaceable on the guide rail, and one transverse support segment and two lateral leg segments, these segments partly enclosing the guide rail, a play-free bearing mounted between the guide rail and the carriage and comprising at least two bearing elements and at least two bearing surfaces at the guide rail to brace and guide the bearing elements, and means to adjust the bearing in playfree manner.

The bearing elements of the present invention are designed in a manner to be rotatable relative to the guide rail and the carriage to adjust the bearing in play-free manner.

Accordingly the design of the linear unit of the present invention is simpler and more economical and allows rapidly matching the linear unit to the most diverse requirements set forth by the customers.

Moreover the rotatable design of the bearing elements assures that they align themselves automatically with the corresponding bearing surfaces when the bearing is adjusted, as a result of which the bearing elements always rest optimally against the bearing surfaces. The carriage rests in playfree manner on the guide rail and as a result may be displaced accurately.

Another object of the present invention is to create a linear unit of reduced noise.

Still another object of the present invention is to create a linear unit with a position detecting module for the linear unit's carriage.

The carriage's lateral leg segments are fitted with at least one seat of substantially cross-sectionally circular or semi-circular shape running over the full carriage length. The inside of the particular lateral segment is fitted with an aperture in the seat, said aperture also running over the full carriage length. The invention's bearing element, which is rotatable relative to the carriage and the guide rail, is configured in the seat. The bearing element is fitted with a retention element of a substantially circular cross-section corresponding to said recess' cross-section. Furthermore the bearing element is fitted with at least one row of rolling elements or with at least one roller resting through the aperture in the seat against one of the guide rail's bearing surfaces.

The linear unit of the present invention is driven by an electric motor in the form of a linear motor which comprises at least one coil and at least one permanent magnet and which generates a translational displacement and which is configured between the guide rail and the carriage. The coil is affixed to the carriage's transverse support segment whereas the permanent magnet is configured in and affixed to in the guide rail and subtends an air gap with the coil. The displaceable part of the linear unit of the invention may be constituted depending on requirement by the carriage or the guide rail.

In a preferred embodiment mode of the present invention, wherein the carriage is designed as the linear unit's displaceable part, the guide rail is asymmetrical and constitutes an asymmetrical seat running over the full length of the guide rail, the linear motor's coil affixed to the carriage entering said seat. The permanent magnet is configured in a recess of the guide rail's base opposite the coil.

Because of the guide rail's asymmetry, the seat of the invention encloses a laterally free space into which may be integrated an electric power harness conventional in such a linear unit and guides and supports flexible cables constituting the electric power harness for the linear motor and a sensor to detect the carriage position when the carriage is moved to-and-fro.

Such an internal configuration of the electrical power harness allows substantially reducing its acoustic noise.

In a further preferred embodiment mode of the linear unit of the present invention, wherein the guide rail is designed as the linear unit's displaceable part, the linear motor's coil is affixed to the carriage's transverse segment outside the guide rail and between said rail and the carriage. In this instance the guide rail is appropriately symmetrical and as compact as possible, the more so that this embodiment mode of the invention is devoid of a displaceable electric power harness that otherwise would have to be housed in the guide rail for purposes of noise reduction. The guide rail merely receives the linear motor's permanent magnet in a recess configured at a side opposite the guide rail's base.

This embodiment of the present invention offers the advantage of reducing the weight of the linear unit's displaceable part and hence also its mechanical inertia. In turn the energy required to move the linear unit's displaceable part is reduced.

In a further preferred embodiment of the linear unit of the present invention, the guide rail is fitted with at least one recess running over the full length of the guide rail and receiving preferably a threaded bar with a trapezoidal thread. Together with a sensor linked to the carriage, the threaded bar constitutes a sensor module to detect the position of the linear unit's displaceable part.

Preferred embodiment modes of the invention are elucidated below in relation to the appended drawings.

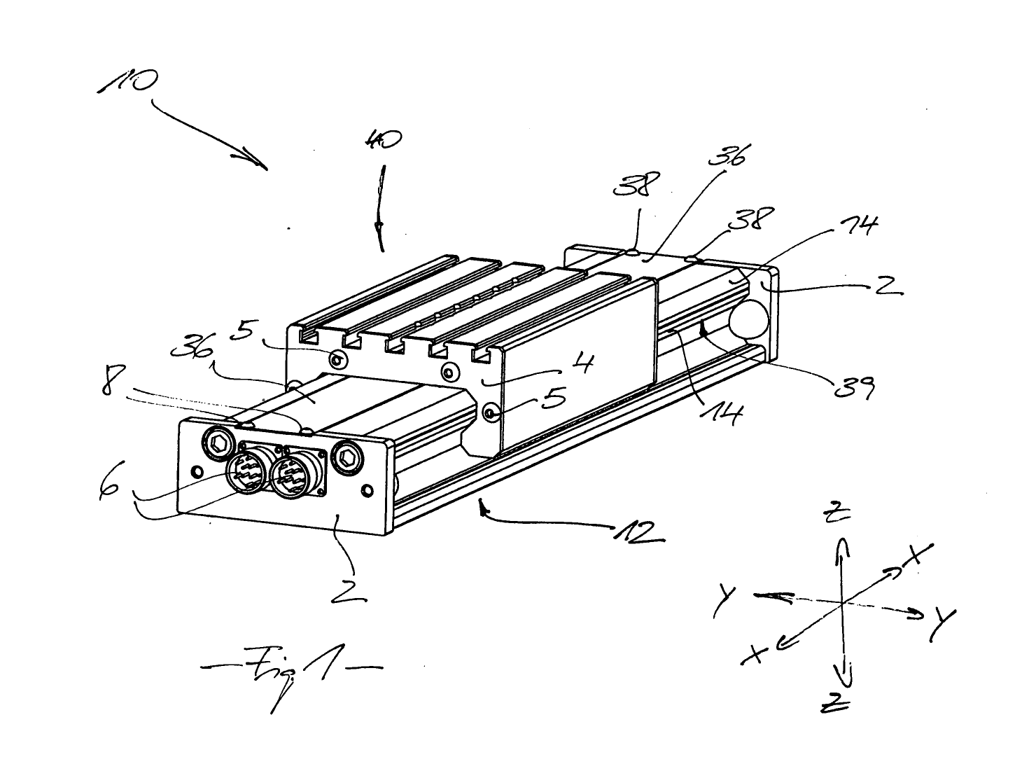

FIG. 1 is a perspective view of a first embodiment mode of the linear unit of the invention,

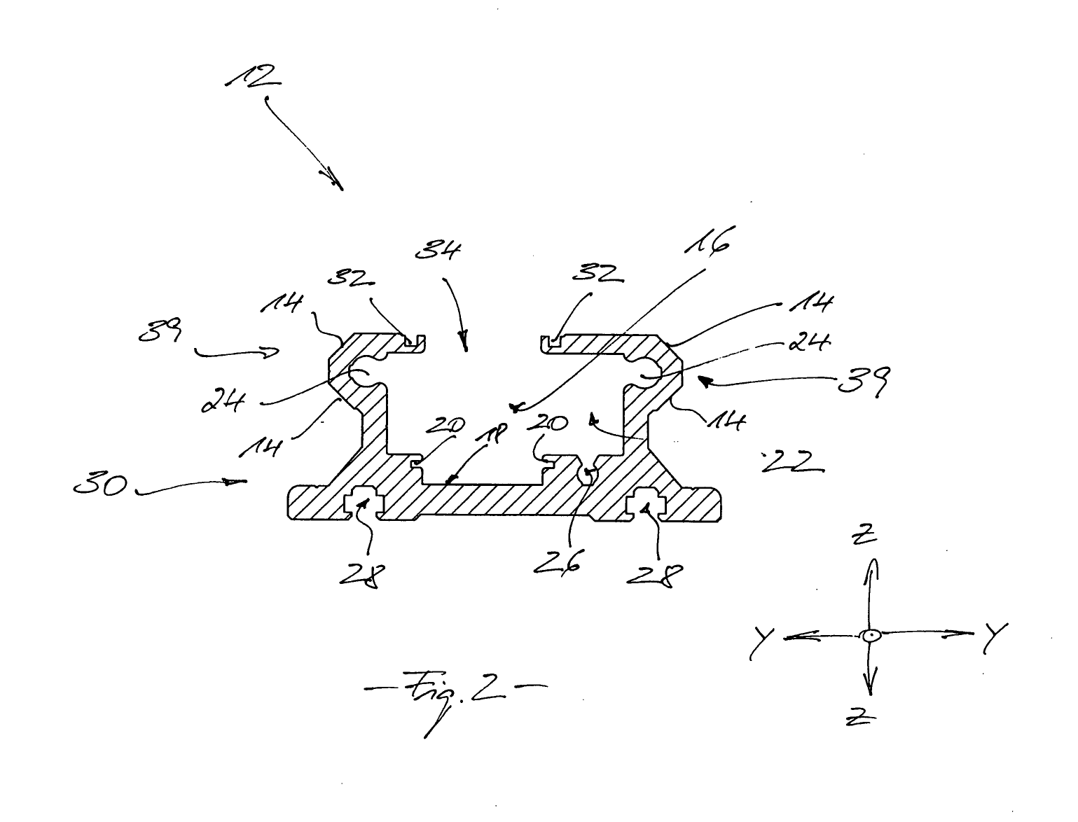

FIG. 2 is a cross-sectional view of the guide rail of the linear unit of FIG. 1,

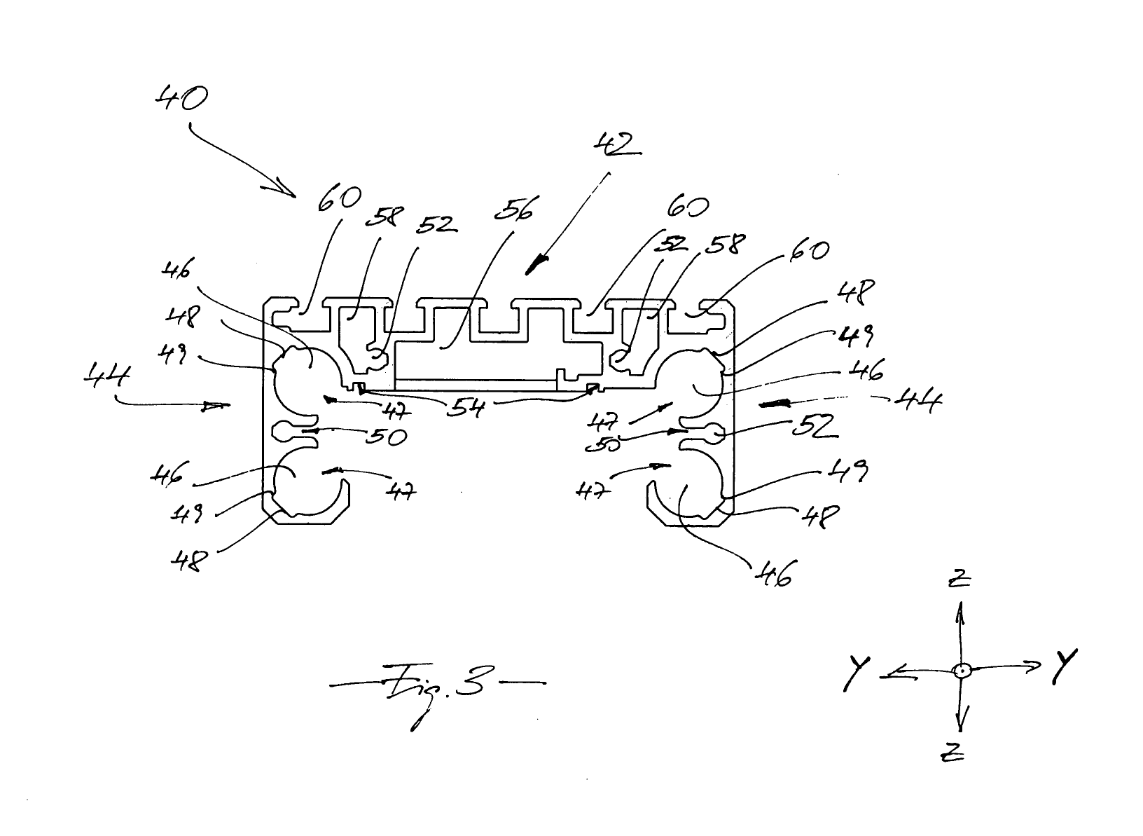

FIG. 3 is a cross-sectional view of the carriage of the linear unit shown in FIG. 1,

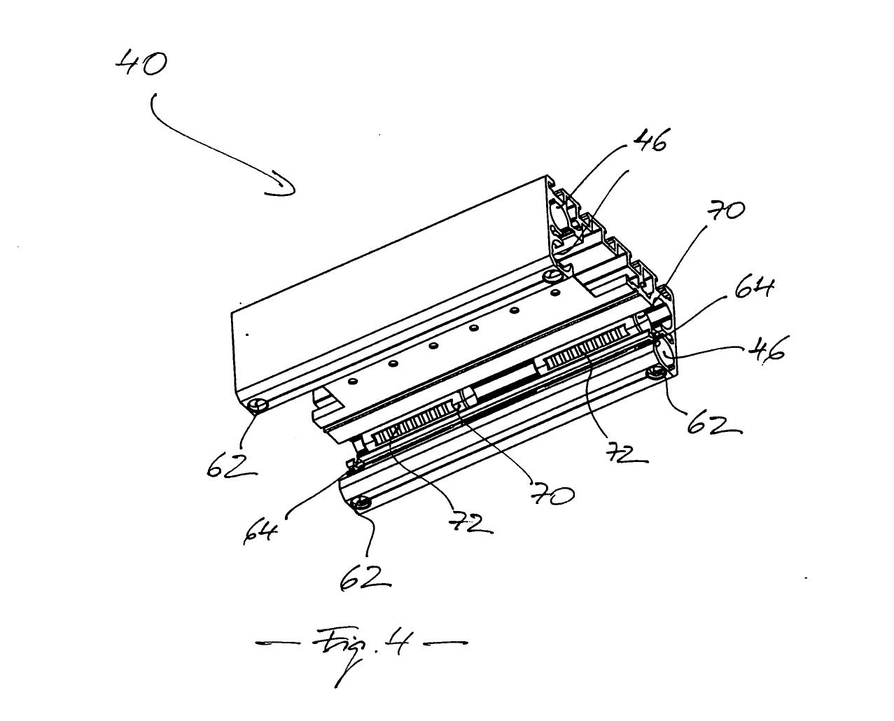

FIG. 4 is a perspective view of the carriage shown in FIGS. 1 and 3 with a first embodiment mode of the bearing elements of the bearing of the linear unit of FIG. 1,

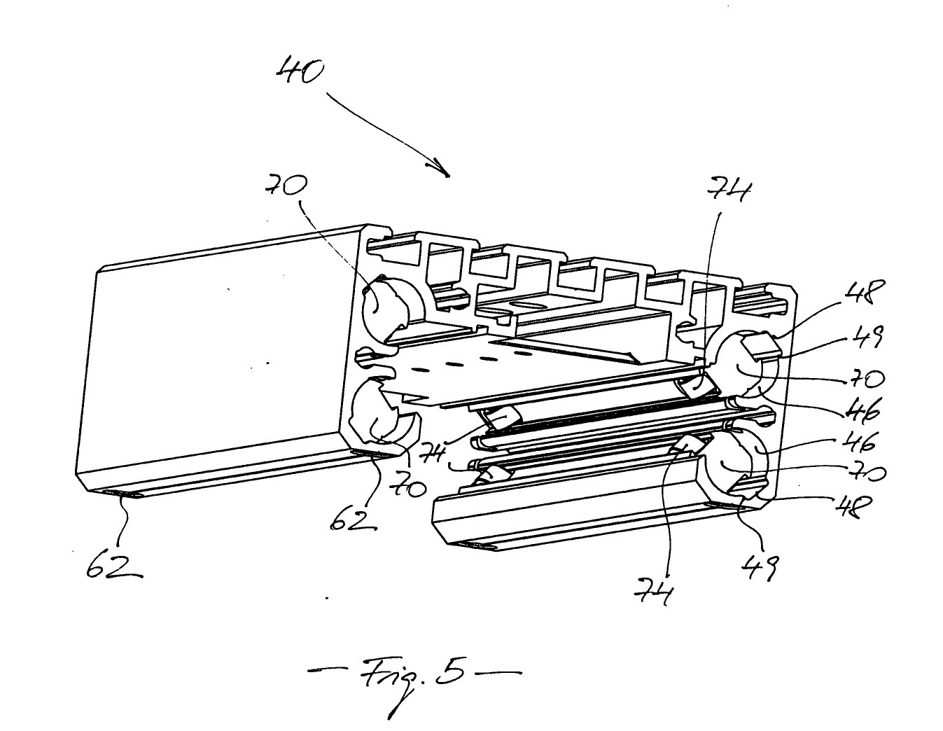

FIG. 5 is a further perspective view of the carriage shown in FIGS. 1 and 3 with a second embodiment mode of the bearing elements of the bearing of the linear unit of FIG. 1,

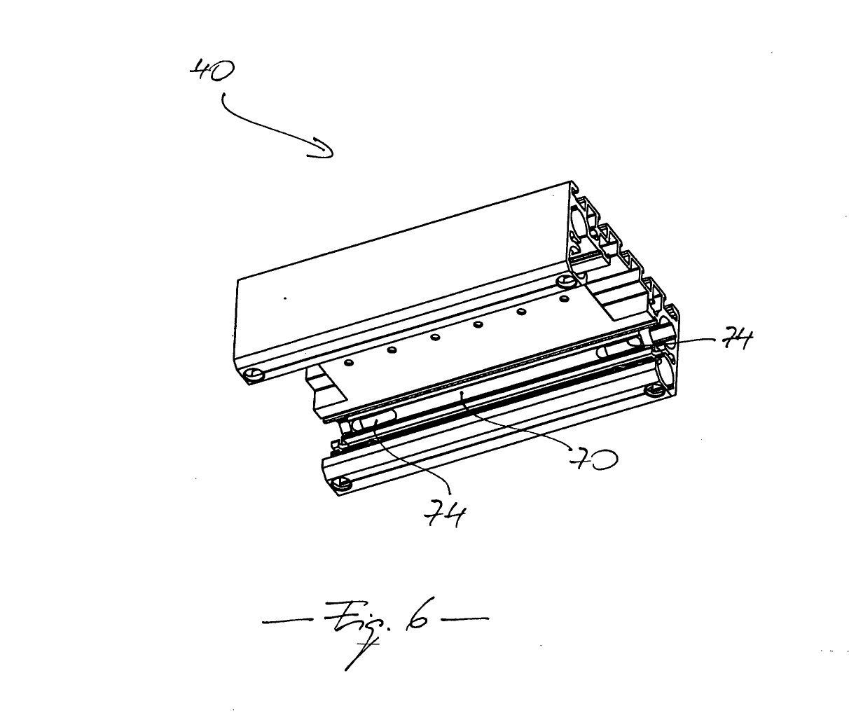

FIG. 6 is a further perspective view of the carriage shown in FIG. 5,

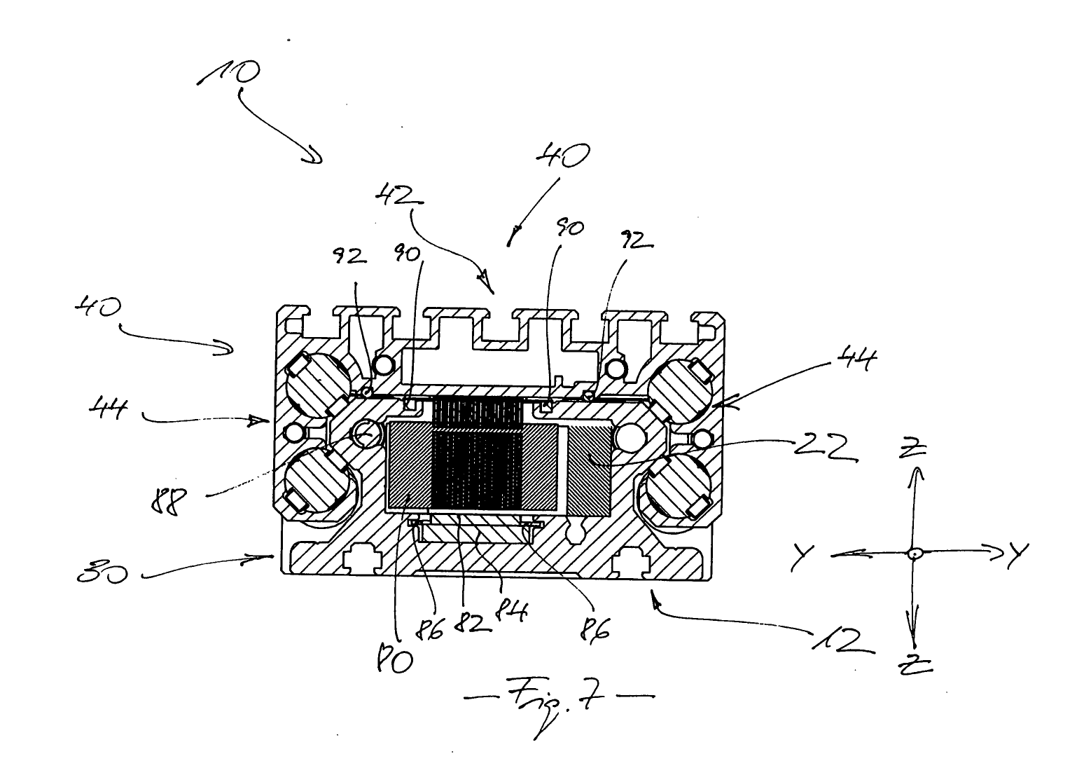

FIG. 7 is a cross-sectional view of the linear unit shown in FIG. 1,

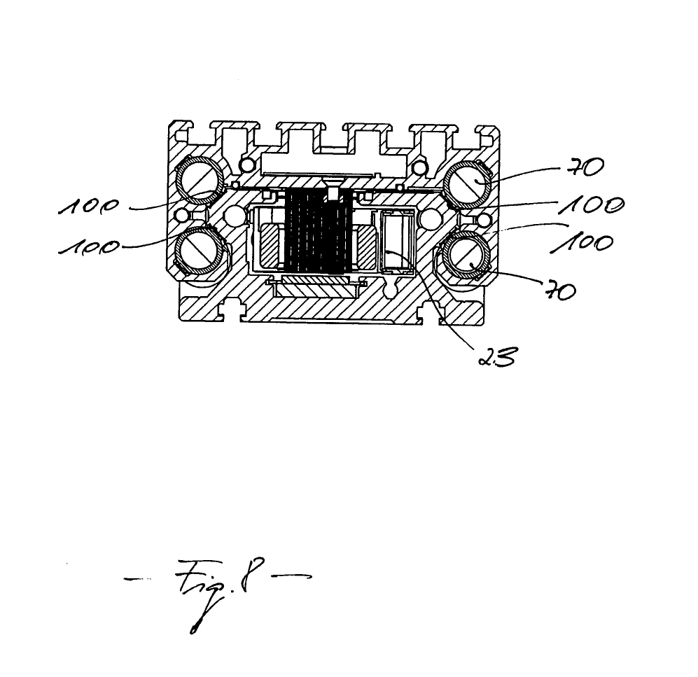

FIG. 8 is a cross-sectional view of a second embodiment mode of the linear unit of the invention,

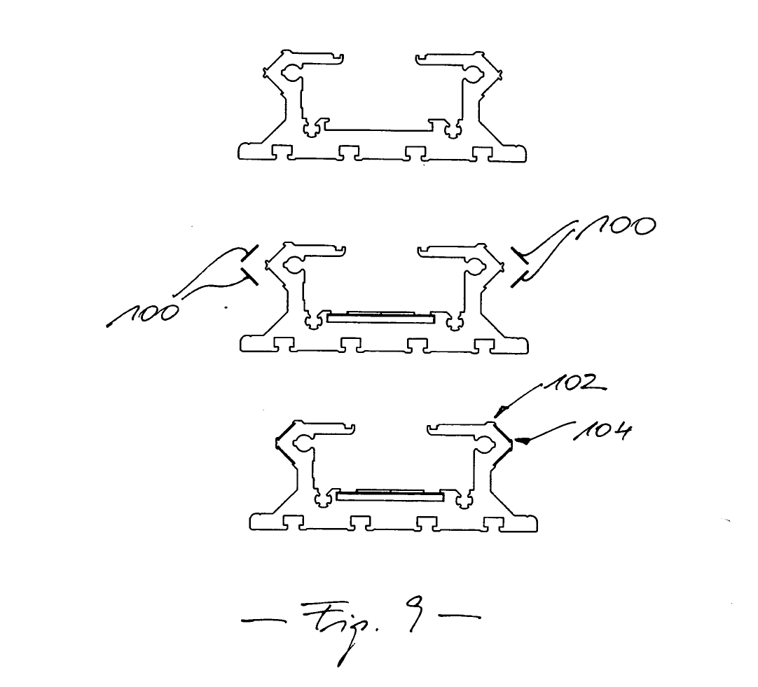

FIG. 9 is an elevation of a guide rail of a third embodiment mode of the linear unit of the invention,

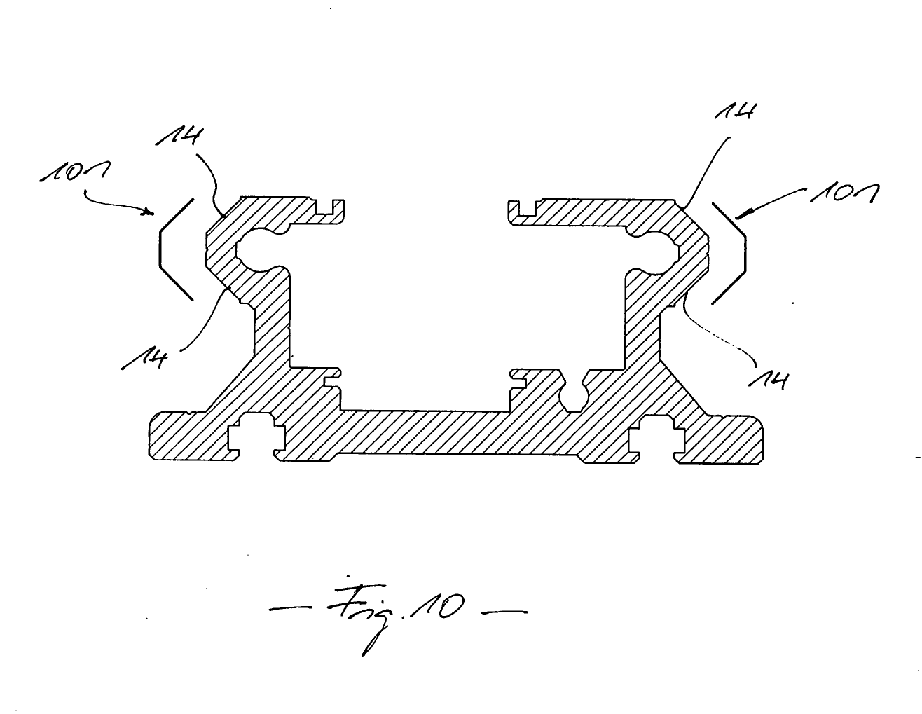

FIG. 10 is a cross-sectional view of a further embodiment mode of the carriage of the linear unit of FIG. 1.

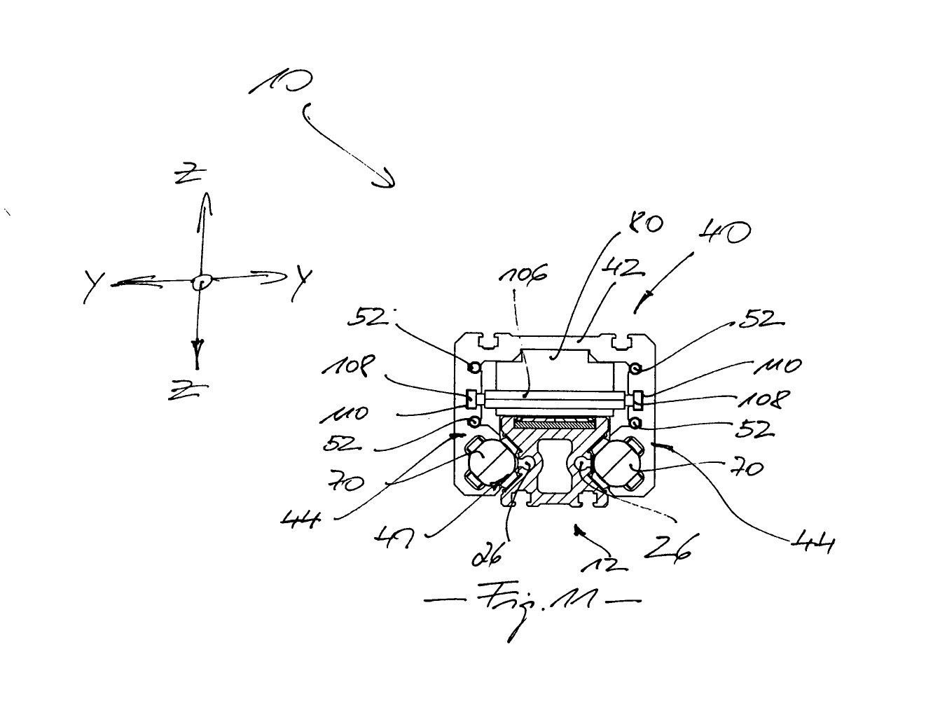

FIG. 11 shows a fourth embodiment mode of the linear of the invention, and

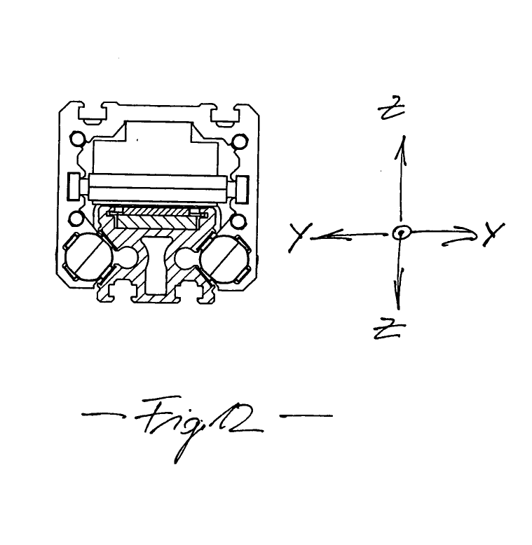

FIG. 12 shows a fifth embodiment mode of the linear unit of the invention.

Below identical reference numerals refer to the same or similar components.

FIG. 1 shows a first preferred embodiment mode of a linear unit 10 comprising a guide rail 12 and a carriage 40 displaceable on it. The carriage 40 assumes a substantially U-shape and includes a transverse support segment 42 and two lateral leg segments 44 (FIG. 3), the segments 42, 44 partly enclosing the guide rail 12 (FIGS. 1 and 7). A play-free bearing is configured between the guide rail 12 and the carriage 40 and comprises on one hand bearing elements and on the other hand bearing surfaces 14 constituted at the guide rail 12 to support and guide the bearing elements. In the present invention, the bearing elements are rotatable relative to the guide rail 12 and the carriage 40 to adjust the bearing in playfree manner. Omitted adjusting elements fitted with screws are configured in the boreholes 62, 64 of the leg segments 44 to allow bearing playfree adjustment in very simple manner when applying a force in a direction Z-Z perpendicular to the longitudinal axis X-X of the particular leg segments 44.

The drive of the linear unit 10 of the invention shown in FIG. 1 is electrical and in the form of a linear motor configured between the guide rail 12 and the carriage 40 and comprises a coil 80 and a permanent magnet 82 (FIG. 7) The coil 80 is affixed to the leg segment 44 of the carriage 40 and extends through an aperture 34 in the asymmetric guide rail 12 into a receiving cavity 16 running over the full length of the guide rail 12. On the other hand the permanent magnet 82 running over the full length of the guide rail 12 is configured jointly with a spacer 84 of the same length in the base 30 of the guide rail 12 in a recess 18 opposite the aperture 34 in a manner that the coil 80 and the guide rail 12 are separated by an air gap. The permanent magnet 82 is suitably affixed relative to the guide rail 12 by means of two flanges 86 of the spacer 84 which laterally of said spacer fit into the grooves 20 of the recess 18 and run over the full length of the guide rail 12.

Operation of the linear motor per se is known to the expert and therefore is not discussed below.

The receiving cavity 16 is asymmetrical in a manner that it encloses a lateral clearance 22 housing the flexible electric power cables in an electric power harness 23 (FIG. 8) for the linear motor, an omitted sensor detecting the position of the carriage 40, said harness per se supporting and guiding said cables. A preferably threaded bar 88 fitted with a trapezoidal thread is configured in the recess 24 of the guide rail 12 opposite the lateral free space 22 and constitutes together with the omitted sensor a simple and economical sensor module acting as an integral component of the linear unit of the invention. The two recesses 24 run over the full length of the guide rail 12 and at the same time receive, at their two ends, screws 8 by means of which the particular end faces of the guide rails 12 are covered by an appropriate plate 2. On the other hand a recess 26 situated in the base 30 of the guide rail and running over the full length of the guide rail 12 serves to receive and guide an omitted hookup cable of the electric terminals 6 of the linear unit 10 of the invention at one of the two ends of said unit.

A metallic cover tape 36 seals off the aperture 34 of the guide rail 12 and is connected thereby to the particular ends of the guide rail 12 by a cover plate 2 and screws 38. One magnetic strip 90 each is mounted in both sides of the aperture 34 in grooves 32 running over the full length of the guide rail 12 and detachably connects the metallic cover tape 36 to the guide rail 12. This cover tape 36 runs through a chamber 56 of one of the three chambers 56, 58 of the transverse support segment 44 of the guide rail 12, the cover tape 36 being detached from the two magnetic strips 90 in the vicinity of the carriage and being guided while loose through the chambers 56. The two chambers 58 configured to the sides of the chamber 56 mainly serve to reduce the weight of the carriage 40 per se.

In the region enclosed by the carriage 40, the guide rail 12 is fitted with two lateral protrusions 39 (FIG. 2) each fitted with two bearing surfaces 14. and enclosed by one of the two leg segments 44 of the carriage 40, the two bearing surfaces 14 subtending an angle preferably of 270° relative to the guide rail 12. The bearing surfaces 14 appropriately are fitted with hard coatings.

Grooves 28 at a side of the base 30 of the guide rail 12 away from the carriage 40 allow affixing the guide rail 12 to a desired site.

A seal 92 is inserted in each groove 54 on both sides of the aperture 34 of the guide rail 12 at the inside of the transverse support segment 42 of the carriage 40 and seals the carriage 40 and the guide rail 12 from each other. At its outside, the transverse support segment 42 is fitted with T-shaped grooves 60 allowing for instance affixing an omitted ground steel plate to hold tools or workpieces.

The lateral leg segments 44 of the carriage 40 each comprise two seats 46 of substantially circular cross-section and running over the full length of the carriage 40. At the inside of the leg segments 44, the seats 46 each are fitted with an aperture 47 which also runs over the full length of the carriage 40. A groove 49 opposite the particular apertures 47 also runs over the full length of the carriage 40 and acts as a further bearing surface 48. One or two bearing elements are configured in the seats 46 and enclose preferably two-part bar-shaped retention elements 70 of substantially circular cross-section.

Two mutually apart retention elements 70 are configured in the embodiment mode of the carriage 40 shown in FIG. 4 in the seats 46 and are fitted preferably with two diametrically arrayed rows of roller elements lubricated with fat that rest on one hand through the aperture 47 against the bearing surface 14 of the guide rail 12 and on the other hand against the bearing surface 48 in the grooves 49 of the carriage 40. Be it borne in mind however that balls or needles also may be used in said rows of rolling elements.

On the other hand and as shown in the embodiment mode of the carriage 40 of FIGS. 5 and 6, only one retention element 70 is received in the seats 46 and is fitted in the carriage end zones preferably with a roller 74 extending through a corresponding rectangular recess in the retention element 70 and resting against the two bearing surfaces 14, 48.

A gap 50 is designed in the two leg segments 44 of the carriage 40 between the seats 46 and widens toward the leg outside by means of a recess 52. These two gaps 50 and recesses 52 impart some flexibility to the leg segments 44 for purposes of playfree bearing adjustment. Two further open recesses 52 open toward the chambers 58 on both sides of the chamber 56 in the transverse support segment 42 act jointly with the two recesses 52 of the leg segments 44 at both ends of the carriage 40 as seats for screws 5 by means of which the particular end faces of the carriage 40 are covered by a matching plate 4,

According to the cross-sectional view of FIG. 8 of a second embodiment mode of the linear unit 10 of the invention, the two protrusions 39 of the guide rail each are fitted with two steel sheets 100 in a manner that said steel sheets constitute the bearing surfaces 14. For that purpose a groove 15 is fitted into the particular surfaces of the guide rail 12 to receive the steel sheet 100. The steel sheets 100 may be affixed by bonding or in mechanically locking manner to the guide rail surfaces, the former instance being implemented by gluing, soldering or welding, and the steel sheets 100 in the latter case being rolled into three grooves.

To roll the steel sheets 100 into place, the grooves of the protrusions 39 are fitted on one side with a dovetail-like undercut 102 and on the other side with rolling-formed flanges 104 used to jam the steel sheet 100 (FIG. 9),

Alternatively according to a third embodiment mode (FIG. 10) of the linear device of the invention, the guide rail 12 may be fitted at the two protrusions 39 with a steel sheet 101 which is bent several times and constitutes the two bearing surfaces 14, said steel sheet matching the shape of the protrusion 39 and enclosing it. The steel sheets 101 preferably are bonded to the guide rail 12.

In the embodiment modes of the linear unit 10 of the invention shown in FIGS. 1 through 10, the carriages 40 always are designed as the displaceable part of the linear unit 10. This design basically corresponds to the conventional applications of such carriages also including the design of several carriages 40. Be it borne in mind however that such embodiment modes also may comprise an inversion of such displacement and that an application also is feasible wherein the rail 12 is acting as the displaceable part of the linear unit 10.

FIGS. 11 and 12 on the other hand show a fourth and fifth embodiment mode of the linear unit 10 of the invention where the guide rail 12 of the previous design acts as the displaceable part. In the latter case the guide rail 12 is designed differently than in the previously described embodiment modes (FIGS. 1 through 10), being appropriately symmetrical and receiving only the permanent magnets 82 of the linear motor in a recess 18 configured at a side of the guide rail 12 opposite the base 30 of said rail. In the region enclosed by the carriage 40, the guide rail 12 is fitted with two lateral offsets 41 each of which is fitted with two grooves constituting the bearing surfaces 14 and a steel sheet 100 was rolled into them as described previously in relation to FIG. 9. The bearing surfaces 14 subtend an angle preferably of 90° relative to the guide rail 12. A recess 26 is configured in the guide rail between the bearing surfaces 14 at the deepest site of each offset 41 and may receive an omitted threaded bar constituting the component of a simple and economical sensor module detecting the carriage position. A sensor belonging to the sensor module might be affixed for this purpose on the carriage 40.

Unlike the case of the previously described embodiment modes (FIGS. 1 through 10), the linear motor's coil 80 affixed to the transverse support segment 42 of the carriage 40 is configured not inside, but outside the guide rail 12 between same and the carriage 40. The two leg segments 44 of the carriage 40 each comprise a substantially semi-circular seat 46 running over the full length of the carriage 40 and configured at the end of the leg segment 44 away from the transverse support segment 42. Two grooves 49 constituting the bearing surfaces 48 and running over the full length of the carriage 40 are present each time in the seats 46, the bearing surfaces 48 of each leg segment 44 preferably subtending between them an angle of 90° relative to the particular leg segment 44. Moreover a bar-shaped retention element 70 preferably in two parts and circular in cross-section is configured in each of the two seats 46, two rollers 74 lubricated with fat mounted in crossing and sequential manner being configured at the ends of said retention element, said rollers passing through corresponding rectangular recesses in the retention element 70 and resting against the bearing surfaces 14, 48 of the guide rail 12 and of the seat 46. The axes of the two rollers 74 subtend a crossing angle of preferably 90° matching the configuration of the bearing surfaces.

Moreover each of the two leg segments 44 is fitted with two gaps respectively recesses 52 between the seat 46 and the transverse support segment 42, one of which is appropriately configured in the transition zone between the leg segment 44 the transverse support segment 42. The two recesses 52 impart some flexibility to the leg segments 44 allowing deforming them for purposes of playfree bearing adjustment. Moreover a preferably T-shaped groove 110 is present in each of the two leg segments 44 between the two recesses 52, said T-shaped groove 110 being open toward the leg inside and running over the full length of leg segment 44. On both sides of the coil 80 in the carriage 40 and transversely configured to its longitudinal axis X-X, elongated hexagons engage by two hexagonal head screws 108 screwed into their ends the groove 110. The hexagons 106 act as adjusting elements allowing playfree adjustment of the bearing when a force is applied in the horizontal direction Y-Y orthogonal to the longitudinal axis X-X of the particular leg segments 44.

The embodiment modes of the linear unit 10 of the invention shown in FIGS. 11 and 12 are especially well suited to vertical setups of same, which also may comprise several carriages 40. The compactness of the displaceable, cross-sectionally contoured rail 12 reduces its weight and mechanical inertia. As a result the energy required to move the displaceable cross-sectionally contoured rail 12 is also reduced.

All the above discussed embodiments of the linear unit of the invention share the common feature that both the guide rail 12 and the carriage 40 are made of integral, extrusion cast aluminum.

Moreover in a further but omitted embodiment mode of the invention, the linear unit 10 is fitted with a braking unit that is preferably designed as an eddy current brake and is an integral component of the linear unit 10. This braking unit decelerates the carriage 40 or stops it in an assigned position.

All above described embodiment modes of the linear unit 10 of the invention share the feature of simple and economic manufacture allowing simple and quick matching of the linear unit 10 to the most diverse requirements.

The rotational design of the bearing elements of the invention assures that when adjusting the bearing by means of the adjusting elements, these bearing elements orient themselves automatically relative to the corresponding bearing surfaces 14, 48. FIG. 12 illustrates the rotation of the bearing elements relative to the carriage 40 and the guide rail 12.

Both the design of the energy chain (FIGS. 1 through 10) guided inside the guide rail 12 and the design of the driven guide rail (FIGS. 1 through 10) and the design of the driven guide rail 12 (FIGS. 11, 12) operate on the basic design of an internal bearing even at high speeds.

1. A linear unit comprising:
at least one guide rail (12),
at least one carriage (40) displaceable on the guide rail (12) and substantially U-shaped and comprising a transverse support segment (42) and two lateral leg segments (44), the segments (42, 44) partly enclosing the guide rail (12),
a playfree bearing between the guide rail (12) and the carriage (40), said bearing comprising at least two bearing elements and at least two bearing surfaces at the guide rail (12) to brace and guide the bearing elements, and means to adjust the bearing in playfree manner characterized
in that the bearing elements are designed in a manner to be rotatable relative to the guide rail (12) and the carriage (40) to allow playfree bearing adjustment.

2. Linear unit as claimed in claim 1, characterized in that the guide rail (12) is fitted with two lateral protrusion (39) or offsets (41) in the zone enclosed by the carriage (40), each of said protrusions/offsets being enclosed by one of the two leg segments (44) of the carriage (40) and comprising at least one of the bearing surfaces (14).

3. Linear unit as claimed in claim 2, characterized in that the two protrusions (36) each comprise two bearing surfaces (14) which, relative to the guide rail, subtend an angle preferably of 270°.

4. Linear unit as claimed in claim 2, characterized in that the two offsets (41) each comprise two bearing surfaces (14) which, relative to the guide rail (12), subtend an angle preferably of 90°.

5. Linear unit as claimed in claim 1, characterized in that the bearing surfaces (14) are hard-coated.

6. Linear unit as claimed in claim 1, characterized in that the bearing surfaces (14) are fitted with at least one steel sheet (100).

7. Linear unit as claimed in claim 1, characterized in that at least one steel sheet (101) bent into surface segments and constituting the bearing surfaces (14) is affixed to both the protrusions (39).

8. Linear unit as claimed in claim 6, characterized in that the steel sheets (100, 101) are bonded to the guide rail (12).

9. Linear unit as claimed in claim 6, characterized in that the steel sheets (100, 101) are connected in mechanically locking manner to the guide rail (12).

10. Linear unit as claimed in claim 9, characterized in that the steel sheet (100) is rolled into a groove 15) in each of the bearing surfaces (14).

11. Linear unit as claimed in claim 10, characterized in that the groove (15) comprises on one side a dovetail-like undercut (102) and on the other side a roller-deformed flange (104) clamping the steel sheet (100).

12. Linear unit as claimed in claim 1, characterized in that the guide rail (12) is asymmetrical and constitutes a receiving cavity (16) for the coil (80) of a linear motor, the aperture (34) of the receiving cavity (16) being configured at the side of the guide rail (12) which faces the transverse support segment (42) of the carriage (40).

13. Linear unit as claimed in claim 12, characterized in that the receiving cavity (16) is designed in a manner that it additionally encloses a lateral free space (22) for an electric power harness (23) for the linear motor and a sensor detecting the position of the carriage (40).

14. Linear unit as claimed in claim 12, characterized in that a recess (18) to receive at least one permanent magnet (82) of the linear motor is situated in the guide rail (12) opposite the aperture (34) of the receiving cavity (16) and runs over the full length of the guide rail (12).

15. Linear unit as claimed in claim 1, characterized in that the guide rail (12) is symmetrical and a recess (18) receiving at least one permanent magnet (82) of the linear motor is fitted into the side facing the transverse support segment (42) of the carriage (40) and runs over the full length of the guide rail (12).

16. Linear unit as claimed in claim 1, characterized in that the lateral leg segments (44) of the carriage (40) each comprise at least one seat (46) for one of the bearing elements, the seat (46) comprising an aperture (47) at the inside of each leg segment (44), said aperture running over the full length of the carriage (40).

17. Linear unit as claimed in claim 16, characterized in that the seat (46) is substantially circular or semi-circular in cross-section.

18. Linear unit as claimed in claim 16, characterized in that at least one further bearing surface (48) to brace and guide the bearing elements, is provided in the particular seats (46), preferably being situated opposite the pertinent aperture (47).

19. Linear unit as claimed in claim 18, characterized in that two bearing surfaces (48) are present in the particular seats (46), where the two bearing surfaces (48) preferably subtend between them an angle of 90° relative to the particular leg segment (44).

20. Linear unit as claimed in claim 1, characterized in that at least one gap (50), open toward the leg inside, is present in both leg segments (44) of the carriage (40), said gap being fitted with a widening (52) toward the leg outside.

21. Linear unit as claimed in claim 20, characterized in that the two leg segments (44) furthermore are fitted with boreholes (62, 64) perpendicular to the longitudinal axes of said segments to receive tightening means adjusting the bearing.

22. Linear unit as claimed in claim 20, characterized in that furthermore another gap open toward the leg inside is present in the transition zones of the carriage (40) between the leg segments (44) and the transverse support segment (42).

23. Linear unit as claimed in claim 22, characterized in that at least one groove (110) open toward the leg inside and running over the full length of the leg segments (44) is fitted into both segments of the carriage (40) each time between the two gaps.

24. Linear unit as claimed in claim 1, characterized in that the bearing elements comprise bar-like retention elements (70) of substantially circular cross-section.

25. Linear unit as claimed in claim 24, characterized in that moreover the bearing elements comprise at least two rows of rolling elements resting against the bearing surfaces (14, 48) the rolling elements of said rows being balls, rollers or needles.

26. Linear unit as claimed in claim 24, characterized in that the bearing elements furthermore comprise at least one roller (74) running through the retention element (70) and resting against the bearing surfaces (14, 48).

27. Linear unit as claimed in claim 26, characterized in that the bearing elements comprise two crossing and sequentially arrayed rollers (74) resting against the bearing surfaces (14, 48), the rollers (74) preferably being configured at a crossing angle of 90°.

28. Linear unit as claimed in claim 1, characterized in that the bearing adjusting means comprise at least one adjusting element configured perpendicularly to the transverse support segment (42) of the carriage (40) in each of the two leg segments (44) of same.

29. Linear unit as claimed in claim 1, characterized in that the bearing adjusting means comprise at least one adjusting element configured perpendicularly to the two leg segments (44) of the carriage (40).

30. Linear unit as claimed in claim 29, characterized in that the adjusting element constitutes an elongated hexagon (106) with inside thread, a hexagonal head screw (108) being inserted at each end of said hexagon.

31. Linear unit as claimed in claim 1, characterized in that the linear unit furthermore comprises a linear motor with a coil (80) and at least one permanent magnet (82) configured between the guide rail (12) and the carriage (40).

32. Linear unit as claimed in claim 1, characterized in that furthermore the linear unit comprises a sensor module with a threaded bar (88) and a sensor detecting the position of the carriage (40).

33. Linear unit as claimed in claim 1, characterized in that the linear unit furthermore comprises a further linear motor acting as a brake.
